(19) United States
(12) Patent Application Publication
(10) Pub. No.: US 2020/0353362 A1
(43) Pub. Date: Nov. 12, 2020

(54) MANAGING ACCESS TO DIGITAL ASSETS

(71) Applicants: Sony Corporation, Tokyo (JP); Sony Music Entertainment, New York, NY (US)

(72) Inventors: Thomas Sachson, Malibu, CA (US); Bradley Spahr, Manhattan Beach, CA (US)

(21) Appl. No.: 16/684,984

(22) Filed: Nov. 15, 2019

Related U.S. Application Data
(60) Provisional application No. 62/845,141, filed on May 8, 2019.

(51) Int. Cl. A63F 13/69; A63F 13/814; A63F 13/79; G06F 16/687; G06F 16/638; G06F 16/64

(52) U.S. Cl. CPC A63F 13/69; A63F 13/814; G06F 16/64; G06F 16/687; G06F 16/638; A63F 13/79

(57) ABSTRACT

Managing access to digital content at a server system in communication with mobile devices including: receiving a user account identifier and performance information from a mobile device; accessing a collectible database storing collectible records; comparing the received performance information with the performance information in the collectible records; accessing a user account database that stores user account records; adding the retrieved collectible identifier to the identified user account record; retrieving a music-related asset identifier from the identified collectible record; and sending a confirmation to the mobile device that indicates the collectible asset has been collected and indicates the retrieved music-related asset identifier.

### CROSS-REFERENCE TO RELATED APPLICATIONS

This application claims the benefits of priority under 35 U.S.C. § 119(e) of co-pending U.S. Provisional Patent Application No. 62/845,141, filed May 8, 2019, entitled “System and method for creating, maintaining, and growing a musically themed digital asset collection game”. The disclosure of the above-referenced application is incorporated herein by reference.

### BACKGROUND

### Field

The present disclosure relates to managing digital assets, and more specifically, to managing digital assets for a musically-themed digital asset collection game.

### Background

Computer-implemented games such as mobile device-based games are increasingly popular, and new uses for the technology are constantly being found. The software may be tied to certain real-world geolocations.

### SUMMARY

The present disclosure provides for managing and collecting digital assets using “performance information” and using the assets to access additional assets.

In one implementation, a system for managing access to digital content is disclosed. The system includes: a music database storing music assets as music data and music asset identifiers for each music asset, wherein the music assets include music-related assets; a collectible database storing collectible records for collectible assets, wherein a collectible record includes data indicating a collectible identifier, a collectible type, a music asset identifier for a music asset associated with the collectible asset, a representation for the collectible asset, and performance information associated with the collectible asset; a user account database storing user account records for users, wherein a user account record includes data indicating an identifier for a user, and a list of collectible identifiers of collectible assets collected by the user; and a processor configured to receive a user account identifier and performance information from a mobile device, to compare the received performance information with the performance information in the collectible records, to identify a collectible record that has the performance information matching the received performance information, to retrieve a collectible identifier for the identified collectible record, to identify a user account record matching the received user account identifier, and to add the retrieved collectible identifier to the identified user account record.

In one implementation, the performance information associated with the collectible asset includes a location of the collectible asset. In one implementation, the performance information associated with the collectible assets includes at least one of completing actions, being at a geolocation, spending an amount of time at a geolocation, being at a geolocation under set conditions, and performing actions at a geolocation physically or digitally. In one implementation, the music-related assets comprise songs, albums, playlists, video, programs, movies, games, and virtual reality (VR) experiences. In one implementation, the collectible identifier includes an image file. In one implementation, the identifier for the user includes at least one of an email address and a mobile device number.

In another implementation, a method for managing access to digital content at a server system in communication with mobile devices is disclosed. The method includes: receiving a user account identifier and performance information from a mobile device; accessing a collectible database storing collectible records including performance information for collectible assets and music-related asset identifiers for music-related assets; comparing the received performance information with the performance information in the collectible records; identifying a collectible record that has performance information matching the received performance information; retrieving a collectible identifier for the identified collectible record; accessing a user account database that stores user account records including user account identifiers and collectible identifiers indicating collectible assets collected by a user account; identifying a user account record matching the received user account identifier; adding the retrieved collectible identifier to the identified user account record to indicate the user account has collected the collectible asset associated with the retrieved collectible identifier; accessing a music database that stores music-related assets as digital data and music-related asset identifiers that correspond to respective music-related assets; retrieving a music-related asset identifier from the identified collectible record; and sending a confirmation to the mobile device that indicates the collectible asset has been collected and indicates the retrieved music-related asset identifier.

In one implementation, the music-related assets comprise songs, albums, playlists, video, programs, movies, games, and VR experiences. In one implementation, the method further includes receiving a request from the mobile device to access a song represented by a music-related asset, where the request includes the retrieved music-related asset identifier. In one implementation, the method further includes identifying the music-related asset in the music database that corresponds to the retrieved music asset identifier. In one implementation, the method further includes sending the digital data corresponding to the identified music-related asset to the mobile device for playback of the song by processing the sent digital data at the mobile device. In one implementation, the performance information for the collectible assets includes location information for the collectible assets. In one implementation, the performance information for the collectible assets includes at least one of completing actions, being at a geolocation, spending an amount of time at a geolocation, being at a geolocation under set conditions, and performing actions at a geolocation physically or digitally. In one implementation, the method further includes enabling the mobile device to access the music-related asset when the confirmation is received by the mobile device. In one implementation, the method further includes creating image representations of the collectible assets. In one implementation, the method includes enabling the mobile device to share information about the collectible assets. In one implementation, sharing information about the collectible assets includes sending images or information about an experience of collecting the collectible assets. In one implementation, the further includes sending collecting points or environment currency, and associated titles or other environment privileges for collecting the collectible assets. In one implementation, the collectible assets include interactive representations with an animated objects or characters.

In another implementation, a non-transitory computer-readable storage medium storing a computer program to manage access to digital content at a server system in communication with mobile devices is disclosed. The computer program includes executable instructions that cause a computer to: receive a user account identifier and performance information from a mobile device; access a collectible database storing collectible records including performance information for collectible assets and music-related asset identifiers for music-related assets; compare the received performance information with the performance information in the collectible records; identify a collectible record that has performance information matching the received performance information; retrieve a collectible identifier for the identified collectible record; access a user account database that stores user account records including user account identifiers and collectible identifiers indicating collectible assets collected by a user account; identify a user account record matching the received user account identifier; add the retrieved collectible identifier to the identified user account record to indicate the user account has collected the collectible asset associated with the retrieved collectible identifier; access a music database that stores music-related assets as digital data and music-related asset identifiers that correspond to respective music-related assets; retrieve a music-related asset identifier from the identified collectible record; and send a confirmation to the mobile device that indicates the collectible asset has been collected and indicates the retrieved music-related asset identifier.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a block diagram of a system for managing access to digital content in accordance with one implementation of the present disclosure;

FIGS. 2A, 2B, and 2C form a flow diagram of a method for managing access to digital content at a server system in accordance with one implementation of the present disclosure;

FIG. 3A is a representation of a computer system and a user in accordance with an implementation of the present disclosure; and

FIG. 3B is a functional block diagram illustrating the computer system hosting the asset managing application in accordance with an implementation of the present disclosure.

### DETAILED DESCRIPTION

As described above, computer-implemented games such as mobile device-based games are increasingly popular, and new uses for the technology are constantly being found. The software may be tied to certain real-world geolocations. Further, if the software is a video game, for example, participants may use such real-world geolocations to compete against other participants in a game, which may include managing and collecting digital assets.

Certain implementations of the present disclosure provide for managing and collecting digital assets using location information and using the assets to access additional assets. In one implementation, a computer system implements a music-themed “scavenger hunt” game that allows users to discover, track, and capture limited and unlimited supply of digital music and digital non-music assets in the real world utilizing location-based services applied to a simplified real world map rendered to a display of the user's mobile device. Once captured by the user, these digital assets or collectibles may be stored, powered up. traded, gifted, ported to another game platform, or disposed of by the user.

Features provided in implementations can include, but are not limited to, one or more of the following items: (a) associating digital assets with other assets, such as associating collectible assets with music assets; (b) associating digital assets with location information, such as associating a collectible asset with a physical location (e.g., GPS coordinates); (c) managing the status of a digital asset based on location information, such as marking a collectible asset as collected for a user account when the location of a mobile device registered to the user account matches the location information of: the collectible asset; and (d) accessing a content asset based on the status of a collectible asset, such as allowing a user account to access a music asset (e.g., play a song) when a collectible asset associated with the music asset is marked as collected for the user account. Therefore, in the new system, computer systems interact to provide access to digital assets, such as music, based on user actions, such as going to particular physical locations.

In one example, a user can listen to a song by visiting a physical location. A network server system includes a music database that stores music assets. The music assets include songs stored as digital data or files and have associated identifiers. The server system also includes a collectible database that stores collectible assets. The collectible assets are in database records that include information indicating an identifier and type of the collectible asset, a music asset associated with the collectible asset, a representation for the collectible asset (e.g., in image file), and a location of the collectible asset (e.g., GPS data for a geolocation in real-world geography). The server system also includes a user account database storing user account information for users of the system. The user account information for a user indicates an identifier for the user (e.g., an email address or a mobile device number) and a list of identifiers of collectible assets that the user has collected.

In one implementation, as a user carrying a mobile device moves (e.g., walks along a street), an application on the mobile device contacts the server system and provides user information and user location information to the server system. The server system checks the collectible database to determine if there is a collectible asset at or near the location of the user by comparing the location information of collectible assets with the user location information. If there is at least one collectible asset at or near the user location, the application causes the mobile device to display indication(s) of the collectible asset(s) by showing the type(s) and representation(s) of the collectible asset(s). If the user indicates to the application to collect the collectible asset(s) (e.g., by selecting the asset(s) in the user interface of the mobile device, such as by tapping on the representations), the application sends a collect request to the server system.

In one implementation, the server system updates the user record to add the collectible asset identifier(s) to the list of collected asset (s) of the user record. The application indicates to the user the music asset(s) associated with the collectible asset(s). If the user selects the music asset(s) through the application and requests to access the music asset(s), the application sends an access request to the server system. The server system accesses the data for the music asset(s) and provides access to the data to the application and mobile device (e.g., by streaming the data to the mobile device for audio playback through the application and mobile device).

The above-described implementation is just one example of a server system providing access to content items. Additional variations and implementations are also possible. Examples include, alone and in combination, and are not limited to: (a) content assets including assets such as music, songs, albums, playlists of songs, videos, programs, movies, games, virtual reality (VR) experiences, digital items in other systems (such as clothing or furniture in a virtual environment or game); (b) collectible assets having representations related to the content assets, such as an album cover or artist image, or images, video, or audio captured and imported by a user (e.g., using a mobile device camera); (c) multiple collectible assets associated with the same content asset and a collectible asset can be associated with multiple content assets; (d) assets collected in various ways or combinations of ways, such as completing actions, being at a geolocation, spending an amount of time at a geolocation, being at a geolocation under set conditions (e.g., time, weather, or temperature), performing actions at a geolocation physically or digitally (e.g., playing a game), viewing or listening to content or advertisements; (e) accessing a collected asset requiring an action, condition, or fee (e.g., in real currency, digital currency, points or other environment or game parameters); (f) creating representations of collected assets, such as an image representation of a shelf or bin containing record albums for collected songs; (g) sharing information about collections with other users, such as sending images or information about a user's collection or experience (screenshots or environment image captures like “selfies”) to other system (e.g., social media or communication platforms); (h) sharing content with other users, such as loaning or renting songs or albums to other users, or allowing other users to play a user's collected songs while the other users are visiting a virtual location of the user (e.g., a virtual room or house); (i) communicating with other users, such as based on common aspects of collections; (j) using augmented reality (AR) for representations of content assets, collectible assets, or other indicators for the system (e.g., an AR arrow in a mobile UI to show which direction to go to find a collectible asset); (k) using collectible assets in other applications or systems as well, such as within a VR environment, a game or shopping experience; (l) combining collectible assets and content assets, such as into collections, packages, or playlists, and shared, optionally with conditions; (m) trading, exchanging, converting, lending, renting, or selling collectible assets and content assets for other assets or privileges; (n) users collecting points or environment currency, and associated titles or other environment privileges from accumulated score; (o) a map user interface displaying locations of collectible assets, such as showing images or icons at locations on the map (e.g., displaying an album cover at map location where the collectible asset for a corresponding music asset in the shown album can be collected), or interactive indicators accessing for additional information such as where collectible assets can be found; (p) collectible asset representations and images are still or animated, showing objects that are fixed, moving, or changing or transforming, such as images of people or faces, or animated icons of people moving (e.g., an animated head of an artist singing, corresponding to the song of the collectible, such as actual artist images or generic types, drummers, heavy metal singers, punk guitar player, etc.); (q) collectible assets are interactive representations or operation, such as an animated person that asks and responds to questions, an animated guitar that plays notes based on user input, an animated person that asks for something from a user and animated to receive the object (e.g., virtual currency or objects, such as objects representing a music contract, first gig, introduction to agent, money, fame), an animated object that must be caught by tapping in a UI or chasing by changing location. An example of one implementation of a digital asset collection and management system is discussed below.

In one example implementation, a music-themed “scavenger hunt” game is disclosed. The game is a proprietary, affordable, robust, secure, adaptable, scalable, and entertaining game that allows the users to discover, track, and capture limited and unlimited supply and digital music and digital non-music assets in the real world. The game utilizes location-based services applied to a simplified real world map rendered to a display of the user's mobile device. Once captured by the user, these digital collectibles may be stored, powered up, traded, gifted, and/or ported to another game platform, or disposed of by the user.

In one implementation, the music-themed mobile game collects music-related digital artifacts including virtualized songs (e.g., singles) and albums (e.g., collections of songs). In the game, collections take place in a geolocation map accessible from the mobile device. Users walk around to find the hidden collectable songs and albums, and once found, the digital asset items are tracked and captured on the mobile device. Further, the user collects the digitized asset of the song or album by simply tapping on the image of the song or album shown on the display of the mobile device, or by tapping on the image of the song or album and performing additional task(s) (e.g., skill based, luck based), such as answering a trivia question(s), performing a physical task on the display of the mobile device (e.g., throwing an object), solving a visual puzzle, or some other analogous task. If the completed task is performed satisfactorily, the digital collectable asset is “captured” by the user and added to the user's collection. The process of storing the collections includes depositing the song or album asset into one or more virtual structures (e.g., a vault, a music listening room, etc.).

In one implementation, the collected (or “captured”) items are stored in the user's own personal record store which the user can visit anytime to admire the personal collections. The record store is also a gathering place for game players (all players or a subset such as within a pre-determined geo-fenced area of perhaps 10 miles of the user), where such other players may gather around certain record bins arranged by genre (e.g., rock, pop, hip-hop, jazz, country) and interact with others with similar musical interests and tastes.

In one implementation, in addition to the songs and albums, the game supports collection of other music and non-music themed digital asset collectibles including: (a) volumetric captures of an artist singing a song; (b) special artist artwork, album art, artist interviews; (c) 2-D videos of songs (e.g., MTV classics); (d) a digital representation of a physical item (e.g., clothing, car, piece of art) associated with the artist; and (d) any other digital asset (e.g., sports, TV, film, history, merchandise themed assets) that may or may not be music themed, but will be of relevance to the players in the game and worthy of collection. Further, some collectibles are only found at certain times and places. For example, some collectibles appear: in cities where an artist once lived; in and around a concert venue on the week of a big concert; only when the location, where the game is being played, has certain music playing in the background to prompt the appearance of certain music themed assets.

In one implementation, the digital assets collected within the mobile game are also capable of being ported to other associated games (e.g., to be placed on display in a VP. Music World game that is associated with the scavenger hunt mobile game). In another implementation, the songs and albums are played within the game (with a per play fee being charged to the user for such play). In another implementation, the user collected songs are deposited into a “mix tape” to be played within the music-themed “scavenger hunt” game, and also to be played within any associated platform (e.g., ported into a VR Music World game). In another implementation, the music-themed “scavenger hunt” game allows users who have collected the same songs or albums to communicate with each other (e.g., social, discovery) if the parties consent in advance to such interactions. In another implementation, some collected digital assets are aggregated and “traded in” for more rare assets (e.g., 12 songs to get one album), in the course of a normal gameplay. In another implementation, some collected digital assets are exchanged for physical merchandise (e.g., real world concert shirts) or services (e.g., real world concert tickets). In another implementation, some collected digital assets are traded or exchanged with others in the game, and in the process the administrator of the music-themed “scavenger hunt” game may collect valuable user data pertaining to tastes and preferences that may be monetized elsewhere. In another implementation, the music-themed “scavenger hunt” game presents advertisements to users in the course of gameplay and reward the users with extra points, digital collectibles, abilities, or analogous items of value. In another implementation, the users accumulate points that may be used to assess their performance with other peers playing the game. In another implementation, photos of digital assets tracked and/or collected are forwarded from the game to the user's external social media or other communications channels. In another implementation, the music-themed “scavenger hunt” game is enabled to use the mobile device camera for photography and/or photogrammetry to scan items such as music art, artist and song memorabilia, and other real-world items and convert the items into 3-D art models for user generated content assets that may be imported into the game for other players.

In a further implementation, the music-themed “scavenger hunt” game leverages the market's love of music and fascination with digital collectibles including: structuring endless music-themed scavenger hunt themed weekends, holidays, events where certain songs, bands, genres are more available for a short period of time or in certain locations; and creatively capturing and storing metaphors borrowing from the music industry (pull a song asset into a virtual MP3 player, lasso a virtual vinyl record with headphones and cord, store captured music assets in playlists that may be shared or exported to Spotify, etc.). In another implementation, the music-themed “scavenger hunt” game makes use of tried and true scavenger hunt engagement techniques including: dropping music-themed virtual lures (tickets, groupies, live shows); sharing or exporting the captured music assets to third-party playlists, social media (e.g., AR enhanced); assembling global teams of Rock, Hip-Hop, Classical, Country, Gospel, and/or Pop; and enabling to add, evolve, and/or power-up a user's collection of music assets that may be showcased to others (asset collection cases, badges for complete sets, collect 12 singles and evolve into complete album, catching rare mixes, etc.).

In a further implementation, the music-themed “scavenger hunt” game incorporates augmented-reality (AR) engagement mechanics including: a location-based collection of music assets tied to music history metadata. In another implementation, a mobile device includes special attributes to enhance a mobile game offering (improving relations with mobile users and carriers alike).

In a further implementation, the music-themed “scavenger hunt” game incorporates neurological reward engagement mechanics including: (a) integrating mature content in a more universally friendly manner through the collection of song; (b) offering endorphin loops for music collection by collecting items needed to catch music assets, successfully collecting a music asset, and “leveling up” a music asset (making it stronger/rarer); and (c) enabling one user's collected song to “battle” another song based on pre-defined rules on chord structure, song length, historic Billboard ranking, etc.

After reading above descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

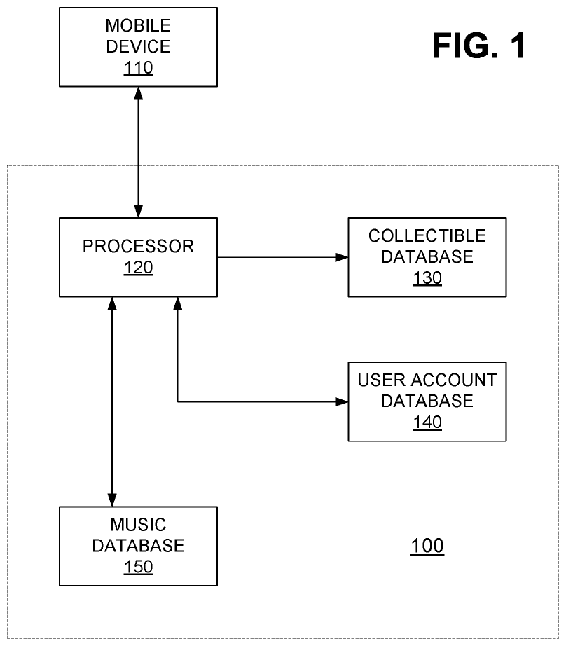

FIG. 1 is a block diagram of a system 100 for managing access to digital content in accordance with one implementation of the present disclosure. In the illustrated implementation of FIG. 1, the system 100 includes a processor 120, a collectible database 130, a user account database 140, and a music database 150. The processor 120 is in communication with a mobile device 110.

In one implementation, the collectible database 130 stores collectible records for collectible assets. A collectible record includes data indicating a collectible identifier, a collectible type, a music asset identifier for a music asset associated with the collectible asset, a representation for the collectible asset, and performance information of the collectible asset. In one implementation, the performance information is location information. In other implementations, the performance information includes at least one of completing actions, being at a geolocation, spending an amount of time at a geolocation, being at a geolocation under set conditions (e.g., time, weather, or temperature), and performing actions at a geolocation physically or digitally (e.g., playing a game).

In one implementation, the user account database 140 stores user account records for users. A user account record includes data indicating an identifier for the user and a list of collectible identifiers of collectible assets that the user has collected.

In one implementation, the music database 150 stores music assets as music data representing songs and music asset identifiers for each music asset. In another implementation, the music database 150 also stores other media assets including at least one asset related to the music asset such as songs, albums, playlists, video, programs, movies, games, and virtual reality (VP) experiences.

In one implementation, the processor 120 is in communication with a mobile device 110. Initially, the processor 120 receives an account identifier of the user and performance information of the collected collectible asset. The processor 120 then compares the received performance information with the performance information of the collectible asset in the collectible records of the collectible database 130. The processor 120 identifies a collectible record that has performance information matching the received performance information, and retrieves a collectible identifier for the identified collectible record.

In one implementation, the processor 120 also identifies a user account record (in the user account database 140) matching the user account identifier received from the mobile device 110. The processor 120 then adds the retrieved collectible identifier (retrieved from the collectable database 130) to the identified user account record to indicate that the user account has collected the collectible asset associated with the retrieved collectible identifier. The processor 120 then retrieves a music asset identifier from the identified collectible record (in the collectible database 130, and sends a confirmation to the mobile device 110 that indicates the collectible asset has been collected and indicates the retrieved music asset identifier. The processor 120 then receives a request from the mobile device 110 to access a song represented by a music asset, where the request includes the retrieved music asset identifier. The processor 120 identifies a music asset in the music database 150 that corresponds to the retrieved music asset identifier, and sends the digital data for the identified music asset to the mobile device 110 for playback of the song as audio.

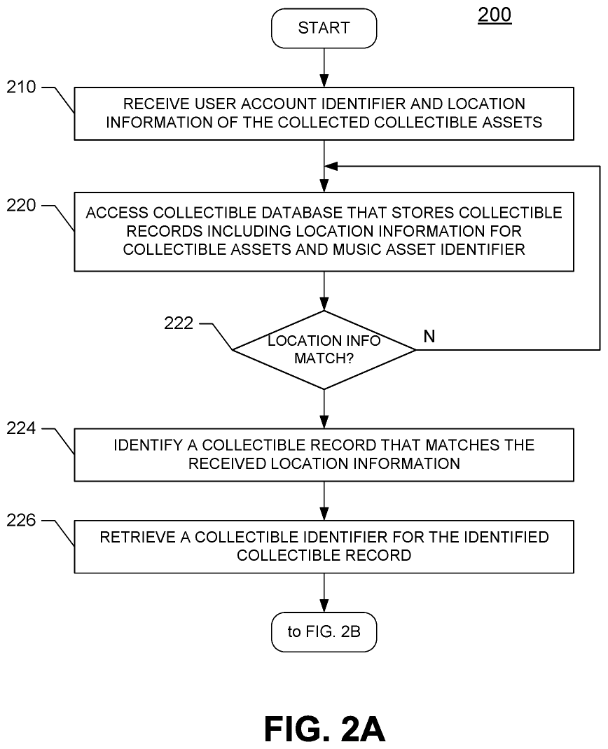

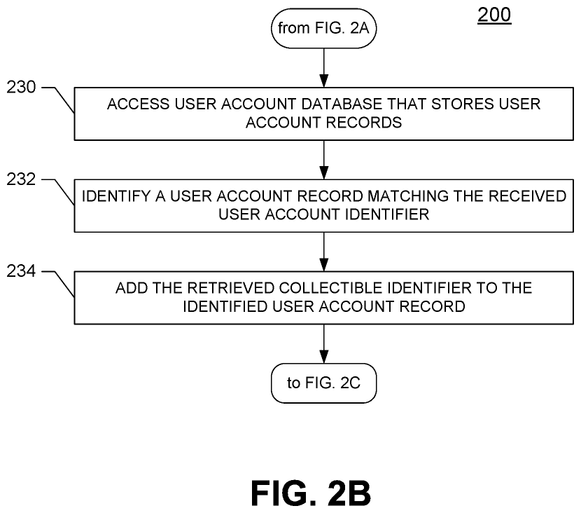

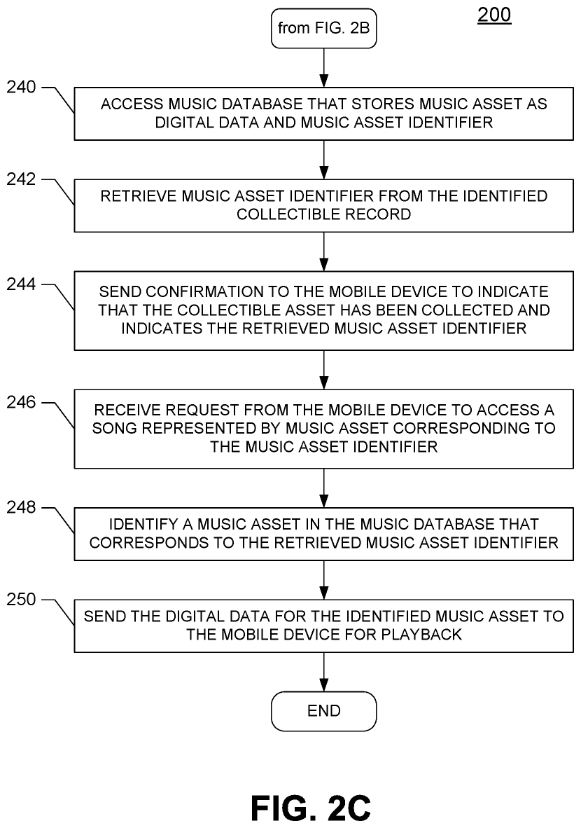

FIGS. 2A, 2B, and 20 form a flow diagram of a method 200 for managing access to digital content at a server system in accordance with one implementation of the present disclosure. In the illustrated implementation of FIG. 2, the method 200 includes receiving user account identifier and performance information of the collected collectible asset from a mobile device, at block 210. In one implementation, the performance information is location information. In other implementations, the performance information includes at least one of completing actions, being at a geolocation, spending an amount of time at a geolocation, being at a geolocation under set conditions (e.g., time, weather, or temperature), and performing actions at a geolocation physically or digitally (e.g., playing a game).

In the illustrated implementation of FIG. 2, the method 200 also includes accessing a collectible database that stores collectible records, at block 220. The collectible records include performance information for collectible assets and music asset identifiers for music assets that correspond to the respective collectible records. The received performance information is then compared with performance information in the collectible records, at block 222. At block 224, a collectible record that has performance information matching the received performance information is identified. A collectible identifier for the identified collectible record is retrieved, at block 226.

In the illustrated implementation of FIG. 2, the method 200 also includes accessing a user account database that stores user account records, at block 230. The user account records include user account identifiers and collectible identifiers indicating collectible assets collected by a user account. A user account record matching the received user account identifier (from the mobile device) is identified, at block 232. The retrieved collectible identifier (retrieved at block 226) is then added, at block 234, to the identified user account record (identified at block 232) to indicate that the user account has collected the collectible asset associated with the retrieved collectible identifier.

In the illustrated implementation of FIG. 2, the method 200 also includes accessing a music database that stores music assets as digital data and music asset identifiers that correspond to respective music assets, at block 240. A music asset identifier is then retrieved, at block 242, from the identified collectible record (identified in block 224), and a confirmation is sent, at block 244, to the mobile device that indicates the collectible asset has been collected and indicates the retrieved music asset identifier. A request from the mobile device to access a song represented by a music asset is received, at block 246, where the music asset corresponds to the retrieved music asset identifier. A music asset is identified, at block 248, in the music database that corresponds to the retrieved music asset identifier. At block 250, the digital data for the identified music asset is then sent to the mobile device for playback of the song as audio by processing the sent digital data at the mobile device.

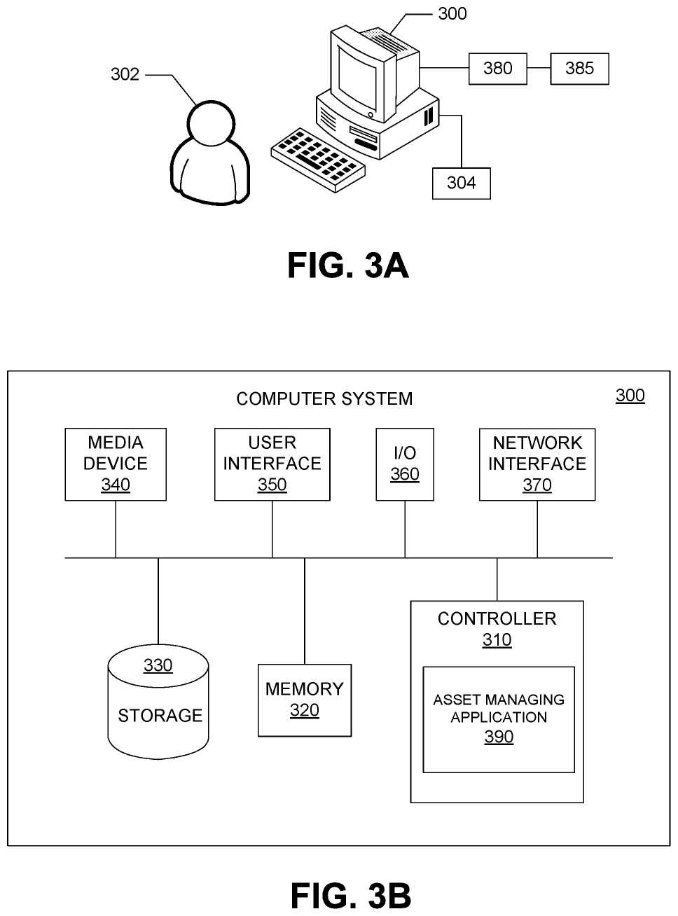

FIG. 3A is a representation of a computer system 300 and a user 302 in accordance with an implementation of the present disclosure. The user 302 uses the computer system 300 to implement an asset managing application 390 as illustrated and described with respect to the system 100 of the block diagram shown in FIG. 1 and the method 200 illustrated in FIGS. 2A, 2B, and 2C.

The computer system 300 stores and executes the asset managing application 390 of FIG. 3B. In addition, the computer system 300 may be in communication with a software program 304. Software program 304 may include the software code for the asset managing application 390. Software program 304 may be loaded on an external medium such as a CD, DVD, or a storage drive, as will be explained further below.

Furthermore, computer system 300 may be connected to a network 380. The network 380 can be connected in various different architectures, for example, client-server architecture, a Peer-to-Peer network architecture, or other type of architectures. For example, network 380 can be in communication with a server 385 that coordinates engines and data used within the asset managing application 390. Also, the network can be different types of networks. For example, the network 380 can be the Internet, a Local Area Network or any variations of Local Area Network, a Wide Area Network, a Metropolitan Area Network, an Intranet or Extranet, or a wireless network.

FIG. 3B is a functional block diagram illustrating the computer system 300 hosting the asset managing application 390 in accordance with an implementation of the present disclosure. A controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the asset managing application 390 with a software system, such as to enable the creation and configuration of engines and data extractors within the asset managing application 390. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Storage 330 stores data either temporarily or for long periods of time for use by the other components of the computer system 300. For example, storage 330 stores data used by the asset managing application 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user of the computer system 300 and presenting information to the user 302. In one implementation, the user interface 350 includes a keyboard, a mouse, audio speakers, and a display. The controller 310 uses input from the user 302 to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 802.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

In one implementation, the system 100 is a system configured entirely with hardware including one or more digital signal processors (DSPs), general purpose microprocessors, application specific integrated circuits (ASICs), field programmable gate/logic arrays (FPGAs), or other equivalent integrated or discrete logic circuitry. In another implementation, the system 100 is configured with a combination of hardware and software.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

Various implementations of the present disclosure are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present disclosure. In addition, the grouping of functions within a module or step is for ease of description. Specific functions can be moved from one module or step to another without departing from the present disclosure.

All features of each above-discussed example are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A system for managing access to digital content, comprising:
a music: database storing music assets as music data and music asset identifiers for each music asset, wherein the music assets include music-related assets;
a collectible database storing collectible records for collectible assets, wherein a collectible record includes data indicating a collectible identifier, a collectible type, a music asset identifier for a music asset associated with the collectible asset, a representation for the collectible asset, and performance information associated with the collectible asset;
a user account database storing user account records for users, wherein a user account record includes data indicating an identifier for a user, and a list of collectible identifiers of collectible assets collected by the user; and
a processor configured to receive a user account identifier and performance information from a mobile device, to compare the received performance information with the performance information in the collectible records, to identify a collectible record that has the performance information matching the received performance information, to retrieve a collectible identifier for the identified collectible record, to identify a user account record matching the received user account identifier, and to add the retrieved collectible identifier to the identified user account record.

2. The system of claim 1, wherein the performance information associated with the collectible asset comprises
a location of the collectible asset.

3. The system of claim 1, wherein the performance information associated with the collectible assets comprises
at least one of completing actions, being at a geolocation, spending an amount of time at a geolocation, being at a geolocation under set conditions, and performing actions at a geolocation physically or digitally.

4. The system of claim 1, wherein the music-related assets comprise songs, albums, playlists, video, programs, movies, games, and virtual reality (VP) experiences.

5. The system of claim 1, wherein the collectible identifier includes an image file.

6. The system of claim 1, wherein the identifier for the user includes at least one of: an email address and a mobile device number.

7. A method for managing access to digital content at a server system in communication with mobile devices, comprising:
receiving a user account identifier and performance information from a mobile device;
accessing a collectible database storing collectible records including performance information for collectible assets and music-related asset identifiers for music-related assets;
comparing the received performance information with the performance information in the collectible records;
identifying a collectible record that has performance information matching the received performance information;
retrieving a collectible identifier for the identified collectible record;
accessing a user account database that stores user account records including user account identifiers and collectible identifiers indicating collectible assets collected by a user account;
identifying a user account record matching the received user account identifier;
adding the retrieved collectible identifier to the identified user account record to indicate the user account has collected the collectible asset associated with the retrieved collectible identifier;
accessing a music database that stores music-related assets as digital data and music-related asset identifiers that correspond to respective music-related assets;
retrieving a music-related asset identifier from the identified collectible record; and
sending a confirmation to the mobile device that indicates the collectible asset has been collected and indicates the retrieved music-related asset identifier.

8. The method of claim 7, wherein the music-related assets comprise songs, albums, playlists, video, programs, movies, games, and VR experiences.

9. The method of claim 7, further comprising
receiving a request from the mobile device to access a song represented by a music-related asset, where the request includes the retrieved music-related asset identifier.

10. The method of claim 9, further comprising
identifying the music-related asset in the music database that corresponds to the retrieved music asset identifier.

11. The method of claim 10, further comprising
sending the digital data corresponding to the identified music-related asset to the mobile device for playback of the song by processing the sent digital data at the mobile device.

12. The method of claim 7, wherein the performance information for the collectible assets comprises
location information for the collectible assets.

13. The method of claim 7, wherein the performance information for the collectible assets comprises
at least one of completing actions, being at a geolocation, spending an amount of time at a geolocation, being at a geolocation under set conditions, and performing actions at a geolocation physically or digitally.

14. The method of claim 7, further comprising
enabling the mobile device to access the music-related asset when the confirmation is received by the mobile device.

15. The method of claim 7, further comprising
creating image representations of the collectible assets.

16. The method of claim 7, further comprising
enabling the mobile device to share information about the collectible assets.

17. The method of claim 16, wherein sharing information about the collectible assets includes
sending images or information about an experience of collecting the collectible assets.

18. The method of claim 7, further comprising
sending collecting points or environment currency, and associated titles or other environment privileges for collecting the collectible assets.

19. The method of claim 7, wherein the collectible assets include interactive representations with an animated objects or characters.

20. A non-transitory computer-readable storage medium storing a computer program to manage access to digital content at a server system in communication with mobile devices, the computer program comprising executable instructions that cause a computer to:
receive a user account identifier and performance information from a mobile device;
access a collectible database storing collectible records including performance information for collectible assets and music-related asset identifiers for music-related assets;
compare the received performance information with the performance information in the collectible records;
identify a collectible record that has performance information matching the received performance information;
retrieve a collectible identifier for the identified collectible record;
access a user account database that stores user account records including user account identifiers and collectible identifiers indicating collectible assets collected by a user account;
identify a user account record matching the received user account identifier;
add the retrieved collectible identifier to the identified user account record to indicate the user account has collected the collectible asset associated with the retrieved collectible identifier;
access a music database that stores music-related assets as digital data and music-related asset identifiers that correspond to respective music-related assets;
retrieve a music-related asset identifier from the identified collectible record; and
send a confirmation to the mobile device that indicates the collectible asset has been collected and indicates the retrieved music-related asset identifier.
